(19) United States
(12) Patent Application Publication
(10) Pub. No.: US 2017/0312990 A1
(43) Pub. Date: Nov. 2, 2017

(54) LUMINOUS DEVICE COMPRISING AT LEAST TWO LASER-WELDED PORTIONS

(71) Applicant: VALEO ILUMINACION, Martos (ES)

(72) Inventors: Juan-Andres ROMAN, Martos (ES); Francisco ALVARO, Martos (ES); Roberto LA-ROSA, Martos (ES)

(73) Assignee: VALEO ILUMINACION, Martos (ES)

(21) Appl. No.: 15/499,104

(22) Filed: Apr. 27, 2017

(30) Foreign Application Priority Data
Apr. 27, 2016 (FR) 16 53729

(51) Int. Cl. B29C 65/16; B29C 65/14; B23K 26/21; B23K 26/324; B29K 101/12; B29K 105/16

(52) U.S. Cl. CPC B29C 65/1635; B23K 26/324; B29C 65/1416; B29C 65/168; B23K 26/21; B29K 2105/16; B29K 2995/002; B29K 2995/0027; B29K 2101/12

(57) ABSTRACT

The present invention relates to a motor vehicle luminous device including at least one first portion that is transparent to at least one laser beam, the portion having at least one first polymer material, and at least one second portion that absorbs the laser beam and is transparent to at least some of the visible spectrum, including at least one second polymer material, the second portion being laser welded to the first portion.

The invention relates to a motor vehicle luminous device comprising at least two portions that are laser welded to each other, and to a process for manufacturing said luminous device.

A motor vehicle luminous device comprises at least one light source and various optical components such as for example a reflector, projecting optics and/or an outer lens allowing the luminous device to be closed.

The various components of a luminous device are in general made from thermoplastics that may be transparent or opaque, colored or not. These thermoplastic components may be fastened to one another by various methods such as adhesive bonding or welding. Among the welding methods conventionally used, laser welding is a method allowing a high-quality weld to be obtained without particle emission.

More particularly, laser welding is conventionally carried out between a first part that is transparent to visible light and transparent to a laser beam, and a second part that absorbs said laser beam. The laser beam thus first passes through the first part in order to reach the second part. The weld is then formed at the interface between the two parts when the laser beam reaches the second part that absorbs said beam. Specifically, at the interface, the second part heats up under the effect of the laser beam, thereby allowing the two parts to be welded.

However, one drawback of the laser welding method as carried out in the prior art is that the weld zone is not optimized, and it may be visible through the first part, this possibly having a negative impact on the aesthetic appearance of the obtained luminous device.

The aim of the present invention is to mitigate the drawbacks of the prior art by providing a luminous device comprising at least two portions that are laser welded by implementing an easy manufacturing process allowing a weld of improved quality to be obtained.

Thus, one subject of the present invention is a motor vehicle luminous device comprising:
at least one first portion that is transparent to at least one laser beam, said portion comprising at least one first polymer material, and
at least one second portion that absorbs said laser beam and that is transparent to at least some of the visible spectrum, comprising at least one second polymer material, said second portion being laser welded to said first portion.

By virtue of the invention, the two portions of the luminous device are welded via a process that is simple to implement and that allows a weld of improved quality to be obtained. Furthermore, the weld is not visible through the second portion and the luminous device therefore has an improved aesthetic appearance. Lastly, the laser welding allows the two portions to be fastened to each other without using toxic compounds and without particle emission.

First and Second Polymer Materials

According to one embodiment of the luminous device of the invention, the first polymer material may comprise at least one in particular amorphous or semicrystalline organic polymer that may be chosen from polymethyl methacrylate (PMMA), polycarbonate (PC), the polymer acrylonitrile butadiene styrene (ABS), polybutylene terephthalate (PBT), acrylonitrile styrene acrylate (ASA), polyethylene terephthalate (PET) and one of the blends thereof.

By way of example of a preferred organic polymer, mention may be made of the transparent polymethyl methacrylate of black color sold by Altuglas International (Arkema group) under the reference Plexiglas V825T black 58015.

According to the invention, the first polymer material may be transparent to one or more laser beams, and may thus comprise at least one polymer that is transparent to said laser beam.

In the present invention, the expression “transparent to at least one laser beam” is understood to mean a polymer, a polymer material or a portion that transmits all of said laser beam in a given wavelength range. The beam thus passes through the polymer, the polymer material or the portion with a small loss of energy, or even without any loss of energy. In particular, the transmitted energy is at least 80%, preferably at least 90%, and more preferably at least 95%, with respect to the energy received by the laser beam.

The first polymer material may furthermore absorb at least some of the visible spectrum, and may thus comprise at least one polymer that absorbs at least some of the visible spectrum.

In the present invention, the visible spectrum consists of all the electromagnetic waves perceived by human vision, in particular electromagnetic waves the wavelengths of which, in free space, are comprised between 380 nm (violet) and 780 nm (red).

In the case where the first polymer material comprises a plurality of polymers that absorb at least some of the visible spectrum, said polymers may absorb light at identical or different wavelengths.

Preferably, the first polymer material may absorb all the visible spectrum, and may thus comprise at least one polymer that absorbs all the visible spectrum.

In the present invention, the expression “that absorbs at least some of the visible spectrum” is understood to mean a polymer, a polymer material or a portion that absorbs at least one wavelength in the visible, and preferably all the wavelengths in the visible.

The second polymer material may comprise at least one in particular amorphous or semicrystalline organic polymer that may be chosen from polymethyl methacrylate (PMMA), polycarbonate (PC), the polymer acrylonitrile butadiene styrene (ABS), polybutylene terephthalate (PBT), acrylonitrile styrene acrylate (ASA), polyethylene terephthalate (PET) and one of the blends thereof.

By way of example of a preferred organic polymer, mention may be made of the polymethyl methacrylate sold by Evonik Rohm GmbH under the reference Plexiglas Heatresist hw55.

According to the invention, the second polymer material is able to absorb one or more laser beams, and may thus comprise at least one polymer that absorbs said laser beam.

In the case where the second polymer material comprises a plurality of polymers that absorb at least one laser beam, said polymers may absorb said laser beam at wavelengths that are identical or different.

In the present invention, the expression “that absorbs a laser beam” is understood to mean a polymer, a polymer material or a portion that absorbs a laser beam in a given wavelength range. Such a polymer, polymer material or such a portion absorbs the energy of the laser beam in this wavelength range.

The second polymer material may furthermore be transparent to at least some of the visible spectrum, and may thus comprise at least one polymer that is transparent to at least some of the visible spectrum.

In the present invention, the expression “transparent to at least some of the visible spectrum” is understood to mean a polymer, a polymer material or a portion that transmits the visible spectrum by refraction and through which objects are visible relatively clearly. More particularly, this polymer, polymer material or this portion, through which an image is observed without significant loss of contrast, means that the interposition of said transparent polymer, said transparent polymer material or said transparent portion between an image and an observer thereof does not significantly decrease the quality of the image. Specifically, in the context of the invention, a transparent polymer, a transparent polymer material or a transparent portion is able to transmit at least some of the incident visible spectrum (or of the incident light) with very little, or even no dispersion. Preferably, the light transmittance, in particular the transmittance of visible light, through the transparent polymer, the transparent polymer material or the transparent portion is at least 87%. Light transmittance is the amount of visible light that the polymer, polymer material or portion that is transparent lets pass, with respect to an incident light ray.

First and Second Portions

In the present invention, the optical component comprises at least one first portion and at least one second portion, the first portion comprising at least the first polymer material and the second portion comprising at least the second polymer material.

The first portion is transparent to one or more laser beams. Thus, the first portion may comprise at least one first polymer material that is transparent to said laser beam. Preferably, the first portion comprises no filler that absorbs said laser beam.

In particular, the first portion may be transparent to one or more laser beams at wavelengths ranging from 800 nm to 1050 nm, preferably from 900 nm to 1000 nm, and more preferably equal to 980 nm.

The first portion may furthermore absorb at least some of the visible spectrum.

In particular, the first portion may absorb visible light at wavelengths ranging from 380 nm to 780 nm.

In the present invention, the absorbance of the first portion in at least some of the visible spectrum may be determined for example using a spectrophotometer operating in transmission or in reflection.

According to a first variant, the first portion may comprise at least one first polymer material that absorbs at least some of the visible spectrum, i.e. a first polymer material such as described above.

According to a second variant, the first portion may comprise at least one first filler that absorbs at least some of the visible spectrum.

In particular, the first filler may absorb at least some of the visible spectrum at wavelengths ranging from 380 nm to 780 nm.

In the case where the first portion comprises a plurality of fillers that absorb at least some of the visible spectrum, said fillers may absorb visible light at identical or different wavelengths.

According to a third variant, the first portion may comprise said first polymer material such as described in the first variant and said first filler such as described in the second variant.

According to this third variant, the first polymer material and the first filler may absorb visible light at identical or different wavelengths.

According to the invention, the first portion may furthermore comprise at least one additive, in particular at least one additive that is well known to those skilled in the art, and that may be chosen from:
coloring agents such as pigments;
anti-UV agents;
protective agents such as antioxidants;
processing agents such as plasticizers, lubricants and oils;
cross-linking agents, such as for example organic peroxides; and
one of the mixtures thereof.

The second portion absorbs one or more laser beams.

In particular, the second portion may absorb at least one laser beam at wavelengths ranging from 800 nm to 1050 nm, preferably from 900 nm to 1000 nm, and more preferably equal to 980 nm.

In the present invention, the absorbance of the second portion to a laser beam may also be determined by spectrophotometer.

According to one preferred embodiment, the second portion absorbs at least one laser beam in a wavelength range to which the first portion is transparent.

According to a first variant, the second portion may comprise at least one second polymer material that absorbs at least one laser beam, such as described above.

According to a second variant, the second portion may comprise at least one second filler that absorbs at least one laser beam.

In particular, the second filler that absorbs at least one laser beam may absorb at wavelengths ranging from 800 nm to 1050 nm, preferably from 900 nm to 1000 nm, and more preferably equal to 980 nm.

In the case where the second portion comprises a plurality of fillers that absorb at least one laser beam, said fillers may absorb the laser beam at wavelengths that are identical or different.

According to a third variant, the second portion may comprise said second polymer material such as described in the first variant and said second filler such as described in the second variant.

According to this third variant, the second polymer material and the second filler may absorb at least one laser beam at wavelengths that are identical or different.

According to the invention, the second portion is transparent to at least some of the visible spectrum. In particular, the second portion may be transparent to wavelengths ranging from 380 nm to 780 nm.

Thus, the second portion may comprise at least one polymer material that is transparent to at least some of the visible spectrum, and optionally at least one filler that is transparent to visible light.

According to the invention, the second portion may furthermore comprise at least one additive, in particular at least one additive that is well known to those skilled in the art, and that may be chosen from:
coloring agents such as pigments (e.g. carbon block);
anti-UV agents;
protective agents such as antioxidants;
processing agents such as plasticizers, lubricants and oils;
cross-linking agents, such as for example organic peroxides; and
one of the mixtures thereof.

According to one particular embodiment, the second portion may be a layer, such as for example a varnish or an ink, applied to a third portion.

According to the invention, the first and/or second portion may be resistant to UV rays. The latter therefore do not damage the portion(s). The first and/or second portion may thus comprise at least one polymer material that is resistant to UV rays and/or at least one filler that is resistant to UV rays.

According to the invention, the first and second portions may respectively have optical properties that are different with respect to visible light and/or the laser beam. More particularly, the first and second portions may respectively comprise the same polymer material(s), but comprise fillers of different nature.

According to the invention, the first portion may have a thickness smaller than 10 mm, and preferably ranging from 2 mm to 6 mm. The second portion may have a thickness smaller than 10 mm, and preferably ranging from 2 mm to 6 mm.

Welding Process

Another subject of the invention is a process for manufacturing the luminous device of the invention comprising the following steps:
i. bringing the first portion and the second portion into contact, then
ii. irradiating said second portion through said first portion with at least said laser beam, in order to weld said second portion to said first portion.

In particular, the first portion may comprise at least one first contact surface, and the second portion may comprise at least one second contact surface, the first and second portions being intended to be welded by welding the first contact surface with the second contact surface.

According to the invention, the first and second contact surfaces are preferably not mechanically modified; in particular their surface roughness is not modified.

Step i

Step i of the process of the invention comprises bringing the first and second portions into physical contact, and in particular bringing the first and second contact surfaces into physical contact. This step of bringing into contact may more particularly be a compressing step allowing the first and second portions to be compressed against each other, in particular via their first and second contact surfaces.

Step ii

Step ii, which is carried out after step i, comprises irradiating, with at least one laser beam, the second portion, in particular level with the second contact surface, through the first portion.

Since the first portion is transparent to the laser beam, the latter reaches the second portion, and in particular the second contact surface, with a small loss of energy, or indeed without loss of energy. Since the second portion has the property of absorbing said laser beam, it absorbs at least some of the laser beam, in particular level with the second contact surface, and melts by heating over a thickness ranging from 2 mm to 3 mm. The first contact surface of the first portion also melts by thermal conduction over a thickness ranging from 2 mm to 3 mm. The first and second polymer materials mix level with the junction between the first and second portions and in particular level with the junction between the first and second contact surfaces.

In step ii of the process of the invention, the laser beam may irradiate the second portion, through the first portion, at a wavelength ranging from 800 nm to 1050 nm, preferably from 900 nm to 1000 nm, and more preferably equal to 980 nm.

In step ii of the process of the invention, the laser beam may irradiate the second portion, through the first portion, with a power ranging from 50 W to 200 W, preferably from 80 W to 150 W, and more preferably of 100 W.

In step ii, the laser beam irradiates the second portion at a temperature above the melting point of the second polymer material.

According to one possible variant, the irradiating step ii may be carried out with a single laser beam, as for example according to the robot laser welding (RLW) method.

According to another possible variant, the irradiating step ii may be carried out with a plurality of laser beams able to simultaneously irradiate at different or identical powers and wavelengths, as for example according to the quasi-simultaneous laser welding method.

The irradiating step ii may last a sufficient length of time to ensure the two parts are securely fastened together.

By way of example, the welding speed may be at least 50 mm/s, preferably at least 60 mm/s and in a particularly preferred way at least 80 mm/s.

Step iii

The welding process of the invention may furthermore comprise the following step, after step i:
iii. irradiating the second portion, and in particular the second contact surface, through the first portion with at least one light beam that is different from the laser beam.

Step iii may be prior to step ii or concomitant with step ii.

The first portion is transparent to the wavelength of this light beam and the second portion is absorbent at the same wavelength.

The light beam may be generated by a halogen lamp that emits in the infrared, and that may also emit in the visible.

In step iii of the process of the invention, the light beam may irradiate the second portion, through the first portion, at a wavelength ranging from 350 nm to 1000 nm, and preferably from 780 nm to 1000 nm.

In this step, the light beam may irradiate the second portion with a power ranging from 800 W to 2000 W, preferably from 900 W to 1500 W, and more preferably equal to 1200 W.

The light beam emitted in step iii allows the second contact surface to be heated and therefore softened over a thickness ranging from 1 mm to 4 mm. This step allows the second portion to more easily conform to the first portion, and in particular the second contact surface to more easily conform to the first contact surface, so as to produce a weld of better quality.

According to one possible variant, step iii may be performed with a plurality of light beams simultaneously, said light beams possibly irradiating at wavelengths and powers that are identical or different.

The duration of irradiation by the light beam may be shorter or equal to the duration of irradiation by the laser beam.

In one particularly preferred embodiment, the radius of the light beam may be larger than that of the laser beam, so that the area irradiated by the radiation of the laser beam is contained within the area irradiated by the light beam.

Step iv

In the process of the invention, once step ii, and optionally step iii, has or have terminated, a step iv of cooling may be carried out. This step may be carried out at room temperature, in particular at a temperature of 25° C., for a length of time ranging from 5 min to 1 h.

In the process of the invention, the step i of bringing into contact may preferably be applied:
during step ii, or
during steps ii and iii, or
during steps ii, iii and iv.

Luminous Device

The present invention preferably applies to the fields of motor vehicle luminous devices.

More particularly, the motor vehicle luminous device may be a luminous lighting and/or signaling device.

By way of example, the luminous device may be a motor vehicle headlight (headlamp) or rear light, or a motor vehicle interior lighting device, but preferably is a motor vehicle rear light.

A motor vehicle luminous device in general comprises a housing closed by an outer lens, in which housing a luminous module is placed.

In the luminous device of the invention, the first portion may be a casing forming a chamber able to accommodate at least one light source and/or at least one luminous module.

In the luminous device of the invention, the second portion may be a closing outer lens.

In particular, the second portion may be a closing outer lens allowing the casing formed by the first portion to be closed.

Other features and advantages of the present invention will become apparent in light of the description of nonlimiting examples of luminous modules according to the invention, which are given with reference to the figures.

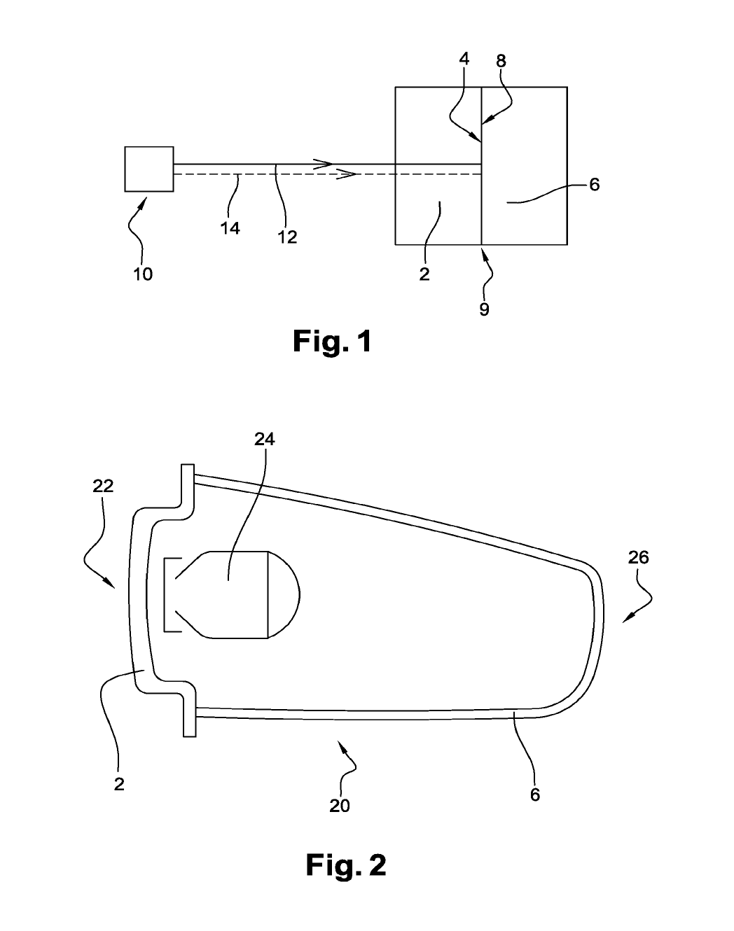

FIG. 1 shows a schematic simplified view of a process for manufacturing a luminous module according to the invention.

FIG. 2 shows a schematic simplified view of a luminous device according to the invention.

For the sake of clarity, only those components that are essential to the comprehension of the invention have been shown, schematically and not to scale.

FIG. 1 shows a schematic simplified view of a process for manufacturing a luminous module according to the invention. A first portion 2 comprises a first contact surface 4 and a second portion 6 comprises a second contact surface 8. According to the process of the invention, the first portion 2 is brought into direct physical contact with the second portion 6, and, in particular, the first contact surface 4 is brought into direct physical contact with the second contact surface 8, forming the contact zone 9. A welding device 10 emits at least one laser beam 12 and at least one light beam 14. The first portion 2 is transparent to the laser beam 12 and to the light beam 14, and the second portion 6 absorbs the laser beam 12 and the light beam 14. Thus, the laser beam 12 irradiates the second portion 6 level with the second contact surface 8 through the first portion 2, allowing the second polymer material of the second portion 6 to be melted, in particular level with the second contact surface 8. The first polymer material and the second polymer material blend level with the contact zone 9, thereby allowing the two portions 2 and 6 to be welded with each other. Concomitantly, the light beam 14 irradiates the second portion 6 level with the second contact surface 8 through the first portion 2. This allows the second polymer material of the second portion 6 to be softened and the second contact surface 8 to better conform with the first contact surface 4, allowing a high-quality weld to be obtained. The irradiation by the light beam 14 furthermore allows the first and second polymer materials to reach their melting point more rapidly.

FIG. 2 shows a schematic simplified view of a luminous device according to the invention. The luminous device 20 comprises a casing 22 that accommodates a luminous module 24, and a closing outer lens 26 allowing the casing 22 to be closed. The casing 22 and the closing outer lens 26 have been welded to each other by the process of the invention such as described in FIG. 1, the casing 22 being formed by the first portion 2 and the closing outer lens 26 being formed by the second portion 6. In this luminous device, the casing 22 is black, and therefore absorbs visible light, and transparent to the laser beam 12 and to the light beam 14. The closing outer lens 26 absorbs the laser beam 12 and the light beam 14.

### EXAMPLE

### Step i

In this exemplary embodiment, the polymer material used for the first portion of the luminous device is the transparent polymethyl methacrylate of black color sold by Altuglas International (Arkema group) under the reference Plexiglas V825T black 58015. This first polymer material:
is transparent to the laser at a wavelength of 980 nm,
possesses a melting point of 230° C., and
is of black color.

The polymer material used for the second portion of the luminous device is the polymethyl methacrylate sold by Evonik Röhm GmbH under the reference Plexiglas Heatresist hw55. This second polymer material:
absorbs the laser at a wavelength of 980 nm,
is transparent to visible light, and
possesses a melting point of 230° C.

In step i of the process, the first portion is brought into contact with the second portion; in particular, the first contact surface of the first portion makes direct physical contact with the second contact surface of the second portion, and the weld will be produced level with these two contact surfaces. A compressing step is carried out in order to guarantee the contact between the two contact surfaces level with the zone to be welded.

### Steps ii and iii

After step i, step ii and step iii are carried out concomitantly and comprise irradiating the second portion through the first portion with a laser beam and a light beam.

The laser beam irradiates the second portion through the first portion at a wavelength of 980 nm and with a power of 120 W, and thus allows the second polymer material to be melted, the temperature level with the second contact surface being comprised between 200° C. and 280° C. The radius of the laser beam is 4 mm, and the welding speed is about 80 mm/s. The second polymer material melts and blends with the first polymer material level with the contact zone.

Concomitantly, the light beam is generated by a halogen lamp that emits in the infrared, and that may also emit in the visible. The power of this halogen lamp is 1200 W and allows the second portion to be softened level with the second contact surface, at a temperature comprised between 80° C. and 90° C., in order to ensure a good conformity of the contact zone. The radius of the light beam is larger than that of the laser beam, so that the area irradiated by the radiation of the laser beam is contained within the area irradiated by the light beam.

### Step iv

After steps ii and iii have been carried out, a cooling step iv is carried out at a temperature of 25° C.

The compression implemented in step i is maintained during steps ii, iii and iv.

The luminous device 20 such as shown in FIG. 2 comprising a casing 22 by way of first portion and a closing outer lens 26 by way of second portion is obtained.

1. Motor vehicle luminous device comprising:
at least one first portion that is transparent to at least one laser beam, said portion comprising at least one first polymer material, and at least one second portionthat absorbs said laser beam and that is transparent to at least some of the visible spectrum, comprising at least one second polymer material, said second portion being laser welded to said first portion.

2. Motor vehicle luminous device according to claim 1, the first polymer material comprises at least one organic polymer chosen from polymethyl methacrylate (PMMA), polycarbonate (PC), the polymer acrylonitrile butadiene styrene (ABS), polybutylene terephthalate (PBT), acrylonitrile styrene acrylate (ASA), polyethylene terephthalate (PET) and one of the blends thereof

3. Motor vehicle luminous device according to Claim 2, wherein the second polymer material comprises at least one organic polymer chosen from polymethyl methacrylate (PMMA), polycarbonate (PC), the polymer acrylonitrile butadiene styrene (ABS), polybutylene terephthalate (PBT), acrylonitrile styrene acrylate (ASA), polyethylene terephthalate (PET) and one of the blends thereof.

4. Motor vehicle luminous device according to any ons claim 3, wherein the second portion comprises at least one second filler that absorbs said laser beam.

5. Motor vehicle luminous device according to claim 4, wherein the first portion is able to absorb at least some of the visible spectrum.

6. Motor vehicle luminous device according to claim 5, wherein the first portion comprises at least one first filler that absorbs at least some of the visible spectrum.

7. Motor vehicle luminous device according claim 1, wherein the first portion is a housing forming a chamber able to accommodate at least one light source and/or at least one luminous module.

8. Motor vehicle luminous device according to any one claim 7, wherein the second portion is a closing outer lens.

9. Process for manufacturing a luminous device according to claim 8, wherein the device comprises the following steps:
i. bringing the first portion and the second portion into contact,
ii. then irradiating said second portion through said first portion with at least said laser beam, in order to weld said second portion to said first portion.

10. Manufacturing process according to claim 9, wherein said laser beam irradiates said second portion at a wavelength ranging from 800 nm to 1050 nm.

11. Manufacturing process according to claim 10, wherein the process furthermore comprises the following step, after step i:
i. irradiating said second portion through said first portion with at least one light beam that is different from the laser beam.

12. Manufacturing process according to claim 11, wherein the light beam irradiates said second portion at a wavelength ranging from 350 nm to 1000 nm.

13. Manufacturing process according to any one of claim 12, wherein the laser beam irradiates the second portion at a temperature above the melting point of the second polymer material.

14. Motor vehicle luminous device according to claim 1, wherein the second polymer material comprises at least one organic polymer chosen from polymethyl methacrylate (PMMA), polycarbonate (PC), the polymer acrylonitrile butadiene styrene (ABS), polybutylene terephthalate (PBT), acrylonitrile styrene acrylate (ASA), polyethylene terephthalate (PET) and one of the blends thereof.

15. Motor vehicle luminous device according to claim 1, wherein the second portion comprises at least one second filler that absorbs said laser beam.

16. Motor vehicle luminous device according to claim 1, wherein the first portion is able to absorb at least some of the visible spectrum.

17. Motor vehicle luminous device according to claim 16, wherein the first portion comprises at least one first filler that absorbs at least some of the visible spectrum.

18. Motor vehicle luminous device according claim 6, wherein the first portion is a housing forming a chamber able to accommodate at least one light source and/or at least one luminous module.

19. Motor vehicle luminous device according to claim 1, wherein the second portion is a closing outer lens.

20. Process for manufacturing a luminous device according to claim 8, wherein the device comprises the following steps:
i. bringing the first portion and the second portion into contact,
ii. then irradiating said second portion through said first portion with at least said laser beam, in order to weld said second portion to said first portion.
